(19) United States
(12) Patent Application Publication
(10) Pub. No.: US 2026/0310610 A1
(43) Pub. Date: Oct. 8, 2026

(54) Hardware-Assisted Dynamic Register Allocation

(71) Applicant: MIPS Tech, LLC, San Jose, CA (US)

(72) Inventors: Abhishek Appu, El Dorado Hills, CA (US); Durgesh Srivastava, Cupertino, CA (US); Cristobal Ramirez Lazo, Austin, TX (US); Bradley Burgess, Sunset Valley, TX (US); Kathlene Magnus, San Antonio, TX (US); Corbin Bremmeyr, Hutto, TX (US)

(21) Appl. No.: 19/172,084

(22) Filed: Apr. 7, 2025

(51) Int. Cl. G06F 12/1045; G06F 9/30; G06F 9/38

(52) U.S. Cl. CPC G06F 12/1063; G06F 9/30101; G06F 9/3867; G06F 2212/657

(57) ABSTRACT

In one embodiment, a method includes accessing an instruction for execution on a processor pipeline, where the instruction is associated with a particular thread of multiple threads of a multi-threaded computing device, and assigning the instruction a virtual register address. The method further includes determining whether the instruction requests to load data from a memory of the computing device, and if so, then; transmitting a load request and the virtual register address to an L1 cache; receiving the requested data from the L1 cache; and by a register allocation manager implemented in dedicated hardware, and after receiving the requested data from the L1 cache, then allocating the particular thread one or more physical registers for execution on the processor pipeline by mapping the virtual register address to a physical address of each of the one or more physical registers.

### TECHNICAL FIELD

This application generally relates to hardware-assisted dynamic register allocation.

### BACKGROUND

Hardware registers are the fastest types of memory available to a computer processor, such as a CPU or a GPU. Registers are typically small, high-speed storage locations used to hold data for a thread that the processor is currently executing. The processor can read from and write to a register much more quickly than to other types of computer memory (e.g., memory in an L1 cache, an L2 cache, RAM, or persistent storage, etc.), reducing the time it takes to perform the data manipulations required by a thread's operations.

A multi-threaded computing device can sequence multiple threads, each directed to a different process, for execution on the computing device's physical processing hardware. Multi-threaded computing devices can typically queue more threads than the device's number of processing pipelines, each of which is associated with a particular set of physical processing hardware. Threads are selected for execution on a particular pipeline by a thread scheduler, which can interleave operations from different threads on a particular pipeline.

While CPUs tend to excel at processing sequential tasks, GPUs tend to excel at processing tasks in parallel, for example as required by many graphics rendering, AI, and machine-learning (ML) operations. For instance, such tasks often involve performing many repetitive calculations (e.g., vector, matrix, and/or tensor operations, etc.) on large datasets, which GPUs can perform efficiently in parallel. Each thread executing on a GPU has a dedicated set of registers, which as described above are the fastest types of memory that a device's processing hardware can access.

### BRIEF DESCRIPTION OF THE DRAWINGS

FIG. 1 illustrates an example method for efficiently managing a register space.

FIG. 2 illustrates an example microarchitecture and flow diagram that implements the example method of FIG. 1.

FIG. 3 illustrates an example computing system.

### DESCRIPTION OF EXAMPLE EMBODIMENTS

The physical space allocated to a microarchitecture's registers can be quite large, particularly for GPUs. For instance, current GPUs use the complier to allocate physical register addresses to a thread, and use a software scoreboard to manage RAW, WAR, and WAW hazards. Such GPUs may have anywhere from, e.g., 128×64 byte registers to 256×64 byte registers, for instance to support a native SIMD 16 with each lane having a width of 4 bytes. This results in a relatively large register space. For example, with support for 8-16 threads per core, the size of the register file may be 512KB to 1MB, which is even larger than the size of the typical L1 cache.

Large registers spaces are needed because each thread is associated with a dedicated set of registers. This approach overcomes registers pressure, which occurs when there is not enough register space to perform the memory operations for the threads currently executing on a processor's pipelines. Register pressure is particularly acute for GPUs, which perform many operations in parallel. Running out of register space drastically decreases throughput, as a spill-fill operation (i.e., loading the data that should be loaded into a register into other computer memory instead until register space is available, at which point the data is fetched and loaded into the register space) is required, and a thread is ready to execute must stall until register space is available. In these approaches, the complier has a transparent view into the physical register space, and assigns each operation in a thread an available physical register address from the set of registers dedicated to that thread.

While dedicating each thread a set of physical registers is a simple and efficient approach to preventing stall, this approach is very demanding on the physical hardware space because a large register space is required to dedicate a set of registers to each thread. In addition, not every thread is always executing, and the dedicated physical register space sits idle when its corresponding thread is not executing, resulting in unused resources. While large, dedicated register size hides latency by reducing the need to use the L1 cache or L2 cache to load and store data, the cost for hiding this latency is a large physical register space, portions of which sit unused.

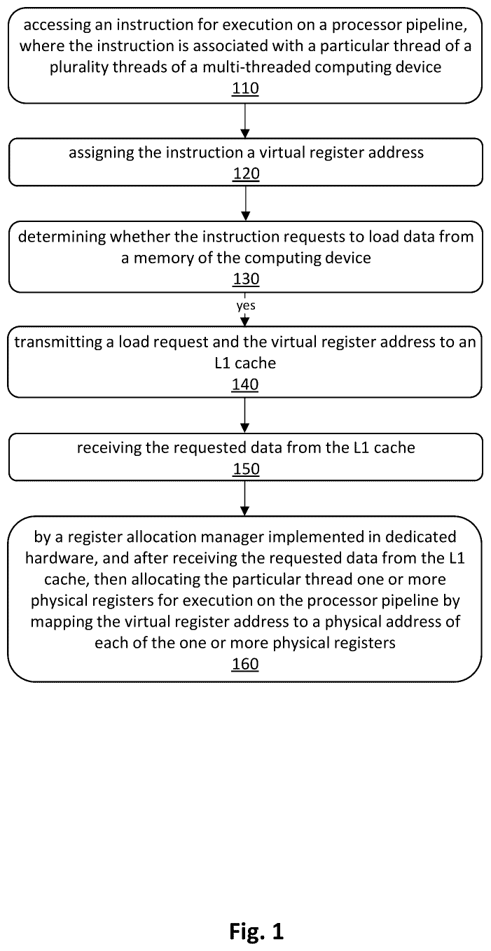

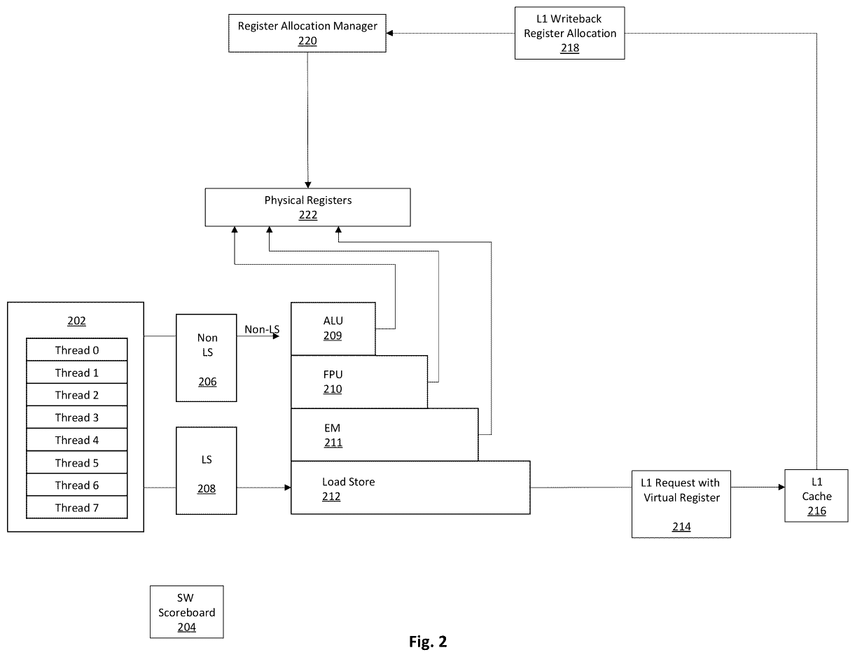

In contrast, FIG. 1 illustrates an example method for efficiently managing a register space. FIG. 2 illustrates an example microarchitecture and flow diagram that implements the example method of FIG. 1, among other things. As described more fully below, the techniques described herein can (1) make more efficient use of a given register space, in part by allocating physical register addresses post L1 cache for load operations, and (2) enables a smaller physical register space to be employed by a particular microarchitecture, freeing up the physical space for other hardware (e.g., increasing the size of the L1 cache) and reducing the resources required to implement the microarchitecture.

Step 110 of the example method of FIG. 1 includes accessing an instruction for execution on a processor pipeline, where the instruction is associated with a particular thread of multiple threads of a multi-threaded computing device. The instruction is typically part of an instruction set architecture designed for the microarchitecture used by the computing device. Processes executed by the computing device are divided into threads. As illustrated in FIG. 2, a multi-threaded computing device can interleave execution of multiple threads onto the processor's pipelines, thereby reducing processer idle time.

The computing device of the example microarchitecture of FIG. 2 includes 8 threads 202. As is typical in a multi-threaded device, the threads cannot all execute at the same time, i.e., the physical execution resources of the computing device do not include dedicated hardware for every thread. The 8 threads therefore need to share the physical execution resources. A multithreaded processor may have multiple execution pipelines, each of which has dedicated physical execution resources. For instance, the 8 threads of the example of FIG. 2 may share 4 pipelines. In general, a computing device with n threads may interleave those threads onto m pipelines, where n>m, and this disclosure contemplates that the number of threads and corresponding execution pipelines may take a variety of values.

In order to avoid stalling the physical execution resources, which decreases throughput, multi-threaded processors typically interleave the threads onto the fewer execution pipelines. In other words, a thread scheduler, which is typically implemented in software, decides which thread to put on which pipeline at any given moment.

Step 120 of the example method of FIG. 1 includes assigning the instruction a virtual register address. For instance, in the example of FIG. 2, an instruction in a thread (e.g., LS instruction 208) executing on a particular pipeline is assigned a virtual register address by the software compiler, but is not a assigned physical register address in physical register space 222 at that time. Physical register space 222 is the collection of physical registers, with corresponding physical addresses, that are used by the computing device to perform processing. To assign a virtual register address, the compiler is presented with a virtual register file (which need not have the same number of virtual registers as the number of physical registers) and assigns the instruction an available virtual register addresses. In particular embodiments, the fact that the address is virtual is opaque to the compiler, i.e., the complier operates the same whether assigning a virtual or physical register address, and therefore modifications to a conventional complier are not needed in order to implement the techniques described herein.

Whether the instruction is an LS instruction or a different instruction, the complier assigns the instruction a virtual register address. As explained below, when the instruction receives a real, physical register address assignment depends on whether the instruction is an LS instruction or an instruction that is immediately ready for execution; in the latter case, the instruction is immediately assigned a physical register address by register allocation manager 220.

Step 130 of the example method of FIG. 1 includes determining whether the instruction requests to load data from a memory of the computing device. In other words, the data that the instruction needs to load in order to execute the instruction is not included with the instruction or otherwise already loaded into the register space. For instance, a load/store (LS) instruction identifies the address of data to be operated on. A load is a relatively slow process as it involves accessing data from the L1 cache, the L2 cache, or other memory (e.g., RAM, hard-disk memory, etc.) of the computing device. Such load requests, even to the L1 cache, take many processor cycles to fulfill.

In contrast, other instructions of an instruction set architecture operate on data that is included in the instruction (e.g., as in a “load immediate” instruction) or operate on data that is already loaded into the physical register space. In the example of FIG. 2, non-LS instructions 206 do not request to load data from the memory of the computing device, while LS instructions 208 do make such requests, and here “LS instruction” refers generically to the latter types of instructions, whether or not such instructions are labelled as a load/store instruction in the instruction set architecture.

Steps 140-160 describe the process that occurs when an accessed instruction requests to load data from the memory of the computing device. These steps illustrate the relatively late allocation of physical register space to a pipelined thread; as a result, no registers in the physical space are dedicated to any particular thread. Step 140 of the example method of FIG. 1 includes transmitting a load request and the virtual register address to an L1 cache. In the example of FIG. 2, load store unit 212 passes the load request and the virtual register address to L1 cache 216 via request 214. L1 cache 216 fetches the data at the specified address either directly (from the L1 cache, if stored) or indirectly (e.g., from the L2 cache or the main memory, if the data is not stored in a more immediate memory). Step 150 of the example method of FIG. 1 includes receiving the requested data from the L1 cache using L1 writeback 218. Writeback 218 includes the requested data and the virtual address assigned earlier to LS instruction 208. As explained above, the process going from LS instruction 208's processing by LS unit 212 to receiving the requested data at register allocation manager 220 takes several processor cycles, during which instruction 208 cannot execute because the requested data is not loaded into the physical register space.

Step 160 of the example method of FIG. 1 includes, by a register allocation manager implemented in dedicated hardware, and after receiving the requested data from the L1 cache, allocating the particular thread one or more physical registers for execution on the processor pipeline by mapping the virtual register address to a physical address of each of the one or more physical registers. For instance, in the example of FIG. 2, register allocation manager 220 is implemented in hardware, i.e., is hardware dedicated to the task of allocating physical register addresses to pipelined processes. Register allocation manager 220 in the example of FIG. 2 maintains a list of virtual-to-physical register mappings, as well as a list of the physical registers that are currently allocated to or occupied by an executing task. In essence, writing into the register allocates physical space in the register via register allocation manager 220, rather than having registers dedicated to particular pipelines.

Once allocated physical register space, the thread that has control of a given pipeline can then execute on that pipeline, using the execution units of that pipeline, until the thread gives up control over the pipeline (in instances involving coarse-grained arbitration, as described below) or the thread present an LS instruction and a thread scheduler gives control of the pipeline to another thread (e.g., using fine-grained arbitration, as described below). In the example of FIG. 2, a pipeline's execution units include an arithmetic logic unit (ALU) 209, a floating-point unit (FPU) 210, and an extended math (EM) unit 211 (e.g., for performing trigonometric operations, etc.), although this disclosure contemplates that various embodiments of a pipeline may have more or fewer execution units.

In particular embodiments, such as illustrated in the example of FIG. 2, a thread scheduler has a varying arbitration approach among threads based on the type of instruction accessed for execution, and on whether the thread is ready for execution. For example, if a thread issues an LS instruction, then the thread scheduler may implement fine-grained thread arbitration, in which thread-switch determinations can be made relatively quickly, e.g., on a per-cycle basis. Thus, if a particular thread that is executing on a pipeline presents a load instruction, then rather than having the execution hardware associated with that pipeline stall while the requested data is accessed and loaded into the physical registers space, another thread can take over the pipeline and begin utilizing the physical execution resources, in order to avoid stall and increase throughput. If the switched thread issues an LS instruction, then fine-grained arbitration is again employed by the thread scheduler to prioritize a thread that can execute immediately.

On the other hand, if the thread executing on a pipeline presents instructions other than an LS instruction, then the thread scheduler implements a coarse-grained arbitration for that pipeline. For instance, the pipeline may only be allocated to a new thread when the current thread deallocates the pipeline, as described below, or when the current thread issues an LS instruction, in which case fine-grained arbitration is employed by the thread scheduler for that pipeline. In addition, when the data identified by a thread's LS instruction is loaded into a register and the thread is given access to the pipeline, then coarse-grained arbitration is used for that pipeline. Thus, a thread that has data ready for execution (i.e. the data to be acted on is available for loading into physical registers 222 or is include in an instruction's operands) and has control of a given pipeline continues executing on that pipeline until the above conditions are met, reducing resource-intensive and time-intensive context switches between threads when a thread is ready for execution on a particular pipeline. On the other hand, fine-grained thread switching is used when a relatively slow load is required, thereby increasing processing throughput and decreasing stall. This disclosure contemplates that, in particular embodiments, the arbitration scheme described above may be preempted as necessary, e.g., based on thread priority, so that critical processes can execute.

As illustrated in the example of FIG. 2, particular embodiments may maintain a software-based scoreboard for threads, such scoreboard 204, so that instructions can execute out of order, if possible. For instance, when a thread executing on a pipeline issues an LS instruction and the thread scheduler allocates the pipeline to another thread that is ready to execute, then the status of the thread associated with the LS instruction may be logged on the scoreboard. When register allocation manager 220 obtains the requested data for the thread and loads the data into the physical register space 222, then the register allocation manager 220 may also clear the scoreboard and update the thread scheduler that the corresponding thread is now ready for execution. The thread scheduler may then allocate a pipeline to the thread, based on the appropriate allocation approaches described above for the threads currently executing on the available pipelines.

As described above, the techniques described herein can reduce the footprint of physical register space 222 while maintaining high throughput. In embodiments in which the physical register space 222 is reduced, register resources are made available through an aggressive deallocation approach in which a thread deallocates register space that was previously allocated to it if the thread has made its last reference to the operand associated with that allocated physical register space. Deallocation may also be performed by a thread when storing the output of a set of operations in the computing device's local or global memory.

For instance, an instruction set architecture may allocate a certain number of bits in an instruction to flag when the corresponding thread is deallocating physical register space. The number of bits used for deallocation may be equal to the number of operands used in the instruction, i.e., an instruction that can have at most three operands will have three bits used for deallocation.

For example, a deallocation bit in an instruction may be set when the thread is making its last reference to that particular operand, meaning that the physical register space no longer needs to store the associated data (as it will not be operated on again). Once a deallocation bit is set, then register allocation manager 220 deallocates the corresponding physical register space, i.e., terminates the virtual-to-physical mapping for that thread (as the associated software typically will only have transparency into the assigned virtual register address). If a thread does need to make further reference to an operand after deallocation, then that thread will be assigned a new virtual address and the register allocation manager will make a new virtual-to-physical register allocation for that thread.

In particular embodiments, if an instruction doesn't have extra bits to assign to deallocation, then the instruction set architecture may include a “deallocate operand” instruction that triggers the deallocation process described above.

In particular embodiments, deallocation bits may be used for situations involving spill/fill. For instance, if there is not enough physical register space to load an operand into, then the computing device will write the instruction to the computing device's memory, and will write to the physical register space once it becomes available.

As described above, the techniques of this disclosure make more efficient use of a given register space, and also permit a relatively smaller register space to be used for a particular microarchitecture. This both decreases the cost required to fabricate the microarchitecture, in part because registers are particularly costly components, as they are bound to the execution units and therefore each register has multiple physical read and write ports, which are complex and expensive to physically construct. Registers are also relatively power hungry, and reducing register space can therefore improve the efficiency of system operation without reducing throughput. Finally, reduced register space frees up physical space in a particular microarchitecture to be put to other uses, such as increasing the size of the L1 cache and therefore reducing post-L1 latencies, which are much greater than L1 latencies. And since the techniques described herein allocate a physical register address to a load operation after returning from the L1 cache, the techniques described herein do not have L1 latencies to hide.

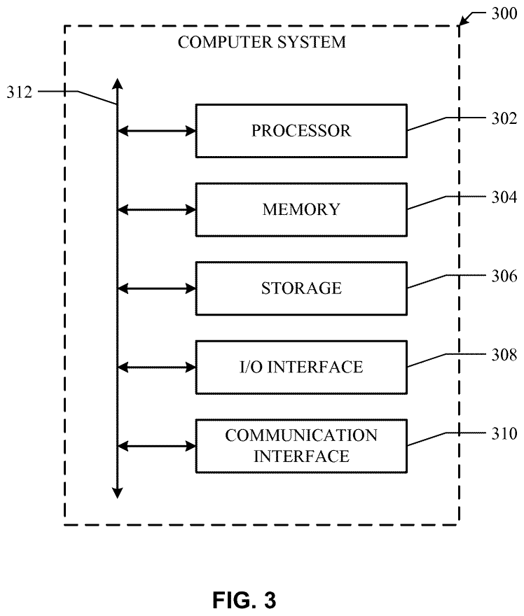

FIG. 3 illustrates an example computer system 300. In particular embodiments, one or more computer systems 300 perform one or more steps of one or more methods described or illustrated herein. In particular embodiments, one or more computer systems 300 provide functionality described or illustrated herein. In particular embodiments, software running on one or more computer systems 300 performs one or more steps of one or more methods described or illustrated herein or provides functionality described or illustrated herein. Particular embodiments include one or more portions of one or more computer systems 300. Herein, reference to a computer system may encompass a computing device, and vice versa, where appropriate. Moreover, reference to a computer system may encompass one or more computer systems, where appropriate.

This disclosure contemplates any suitable number of computer systems 300. This disclosure contemplates computer system 300 taking any suitable physical form. As example and not by way of limitation, computer system 300 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 300 may include one or more computer systems 300; be unitary or distributed; span multiple locations; span multiple machines; span multiple data centers; or reside in a cloud, which may include one or more cloud components in one or more networks. Where appropriate, one or more computer systems 300 may perform without substantial spatial or temporal limitation one or more steps of one or more methods described or illustrated herein. As an example and not by way of limitation, one or more computer systems 300 may perform in real time or in batch mode one or more steps of one or more methods described or illustrated herein. One or more computer systems 300 may perform at different times or at different locations one or more steps of one or more methods described or illustrated herein, where appropriate.

In particular embodiments, computer system 300 includes a processor 302, memory 304, storage 306, an input/output (I/O) interface 308, a communication interface 310, and a bus 312. Although this disclosure describes and illustrates a particular computer system having a particular number of particular components in a particular arrangement, this disclosure contemplates any suitable computer system having any suitable number of any suitable components in any suitable arrangement.

In particular embodiments, processor 302 includes hardware for executing instructions, such as those making up a computer program. As an example and not by way of limitation, to execute instructions, processor 302 may retrieve (or fetch) the instructions from an internal register, an internal cache, memory 304, or storage 306; decode and execute them; and then write one or more results to an internal register, an internal cache, memory 304, or storage 306. In particular embodiments, processor 302 may include one or more internal caches for data, instructions, or addresses. This disclosure contemplates processor 302 including any suitable number of any suitable internal caches, where appropriate. As an example and not by way of limitation, processor 302 may include one or more instruction caches, one or more data caches, and one or more translation lookaside buffers (TLBs). Instructions in the instruction caches may be copies of instructions in memory 304 or storage 306, and the instruction caches may speed up retrieval of those instructions by processor 302. Data in the data caches may be copies of data in memory 304 or storage 306 for instructions executing at processor 302 to operate on; the results of previous instructions executed at processor 302 for access by subsequent instructions executing at processor 302 or for writing to memory 304 or storage 306; or other suitable data. The data caches may speed up read or write operations by processor 302. The TLBs may speed up virtual-address translation for processor 302. In particular embodiments, processor 302 may include one or more internal registers for data, instructions, or addresses. This disclosure contemplates processor 302 including any suitable number of any suitable internal registers, where appropriate. Where appropriate, processor 302 may include one or more arithmetic logic units (ALUs); be a multi-core processor; or include one or more processors 302. Although this disclosure describes and illustrates a particular processor, this disclosure contemplates any suitable processor.

In particular embodiments, memory 304 includes main memory for storing instructions for processor 302 to execute or data for processor 302 to operate on. As an example and not by way of limitation, computer system 300 may load instructions from storage 306 or another source (such as, for example, another computer system 300) to memory 304. Processor 302 may then load the instructions from memory 304 to an internal register or internal cache. To execute the instructions, processor 302 may retrieve the instructions from the internal register or internal cache and decode them. During or after execution of the instructions, processor 302 may write one or more results (which may be intermediate or final results) to the internal register or internal cache. Processor 302 may then write one or more of those results to memory 304. In particular embodiments, processor 302 executes only instructions in one or more internal registers or internal caches or in memory 304 (as opposed to storage 306 or elsewhere) and operates only on data in one or more internal registers or internal caches or in memory 304 (as opposed to storage 306 or elsewhere). One or more memory buses (which may each include an address bus and a data bus) may couple processor 302 to memory 304. Bus 312 may include one or more memory buses, as described below. In particular embodiments, one or more memory management units (MMUs) reside between processor 302 and memory 304 and facilitate accesses to memory 304 requested by processor 302. In particular embodiments, memory 304 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 304 may include one or more memories 304, where appropriate. Although this disclosure describes and illustrates particular memory, this disclosure contemplates any suitable memory.

In particular embodiments, storage 306 includes mass storage for data or instructions. As an example and not by way of limitation, storage 306 may include a hard disk drive (HDD), a floppy disk drive, flash memory, an optical disc, a magneto-optical disc, magnetic tape, or a Universal Serial Bus (USB) drive or a combination of two or more of these. Storage 306 may include removable or non-removable (or fixed) media, where appropriate. Storage 306 may be internal or external to computer system 300, where appropriate. In particular embodiments, storage 306 is non-volatile, solid-state memory. In particular embodiments, storage 306 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 306 taking any suitable physical form. Storage 306 may include one or more storage control units facilitating communication between processor 302 and storage 306, where appropriate. Where appropriate, storage 306 may include one or more storages 306. Although this disclosure describes and illustrates particular storage, this disclosure contemplates any suitable storage.

In particular embodiments, I/O interface 308 includes hardware, software, or both, providing one or more interfaces for communication between computer system 300 and one or more I/O devices. Computer system 300 may include one or more of these I/O devices, where appropriate. One or more of these I/O devices may enable communication between a person and computer system 300. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 308 for them. Where appropriate, I/O interface 308 may include one or more device or software drivers enabling processor 302 to drive one or more of these I/O devices. I/O interface 308 may include one or more I/O interfaces 308, where appropriate. Although this disclosure describes and illustrates a particular I/O interface, this disclosure contemplates any suitable I/O interface.

In particular embodiments, communication interface 310 includes hardware, software, or both providing one or more interfaces for communication (such as, for example, packet-based communication) between computer system 300 and one or more other computer systems 300 or one or more networks. As an example and not by way of limitation, communication interface 310 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 310 for it. As an example and not by way of limitation, computer system 300 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 300 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 300 may include any suitable communication interface 310 for any of these networks, where appropriate. Communication interface 310 may include one or more communication interfaces 310, where appropriate. Although this disclosure describes and illustrates a particular communication interface, this disclosure contemplates any suitable communication interface.

In particular embodiments, bus 312 includes hardware, software, or both coupling components of computer system 300 to each other. As an example and not by way of limitation, bus 312 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 312 may include one or more buses 312, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure contemplates that the circuitry of a computing device may include circuitry that performs operations in response to output by software executing on the computing device. For example, circuity of a computing device for assigning an instruction a virtual address register address may make such assignment based on the assignment determination made by a software compiler executing on the computing device. As another example, circuity of a computing device for arbitrating a set of threads' access to a set of pipelines may perform such arbitration in response to determinations made by a thread scheduler, and that thread scheduler may be implemented by software executing on the computing device.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend.

What is claimed is:

1. A method comprising:
accessing an instruction for execution on a processor pipeline, wherein the instruction is associated with a particular thread of a plurality threads of a multi-threaded computing device;
assigning the instruction a virtual register address;
determining whether the instruction requests to load data from a memory of the computing device;
in response to a determination that the instruction requests to load data from the memory of the computing device, then:
transmitting a load request and the virtual register address to an L1 cache;
receiving the requested data from the L1 cache; and
by a register allocation manager implemented in dedicated hardware, and after receiving the requested data from the L1 cache, then allocating the particular thread one or more physical registers for execution on the processor pipeline by mapping the virtual register address to a physical address of each of the one or more physical registers.

2. The method of claim 1, wherein the physical registers comprise GPU registers.

3. The method of claim 1, further comprising
in response to a determination that the instruction does not request to load data from the memory of the computing device, then immediately allocating, by the register allocation manager, the particular thread one or more physical registers for execution.

4. The method of claim 1, further comprising:
in response to the determination that the instruction requests to load data from the memory of the computing device, then arbitrating, by a thread scheduler, execution on the processor pipeline among the plurality of threads on a fine-grained basis.

5. The method of claim 4, further comprising:
in response to the determination that the instruction does not request to load data from the memory of the computing device, then arbitrating, by the thread scheduler, execution on the processor pipeline among the plurality of threads on a coarse-grained basis.

6. The method of claim 1, further comprising:
executing, by one or more execution units of the processor pipeline and after loading the requested data into the physical register space, one or more instructions from the particular thread;
receiving, from the particular thread and at the register allocation manager, a deallocation command associated with the loaded data; and
deallocating, by the register allocation manager, the one or more physical register addresses for the thread.

7. The method of claim 6, wherein a thread scheduler arbitrates access to the processor pipeline among the plurality of threads on a coarse-grained basis while the one or more instructions from the particular thread are executing until (1) the deallocation command is received or (2) the one or more instructions comprise a load request.

8. The method of claim 6, wherein the deallocation command comprises a particular value of a deallocation bit in one of the one or more instructions.

9. The method of claim 8, wherein a number of deallocation bits in each of the one or more instructions is equal to a number of operands in each of the respective one or more instructions.

10. The method of claim 6, wherein the deallocation command comprises a deallocation instruction.

11. A multi-threaded computing device, comprising:
a physical register space;
a set of execution units coupled to the physical register space;
an L1 cache;
circuitry configured to:
access an instruction for execution on a processor pipeline of the computing device, wherein the instruction is associated with a particular thread of a plurality threads of the multi-threaded computing device;
assign the instruction a virtual register address;
determine whether the instruction requests to load data from a memory of the computing device;
in response to a determination that the instruction requests to load data from the memory of the computing device, then transmit, by a load-store unit of the set of execution units, a load request and the virtual register address to an L1 cache; and
a register allocation manager coupled to the physical register space and to the L1 cache, comprising circuitry configured to:
receive the requested data from the L1 cache;
after receiving the requested data from the L1 cache, then allocate the particular thread one or more physical registers for execution on the processor pipeline by mapping the virtual register address to a physical address of each of the one or more physical registers.

12. The computing device of claim 10, wherein the physical registers comprise GPU registers.

13. The computing device of claim 10, wherein the register allocation manager further comprises circuitry configured to immediately allocate, in response to a determination that the instruction does not request to load data from the memory of the computing device, the particular thread one or more physical registers for execution.

14. The computing device of claim 10, further comprising circuitry configured to, in response to the determination that the instruction requests to load data from the memory of the computing device and based on output of a thread scheduler, arbitrate execution on the processor pipeline among the plurality of threads on a fine-grained basis.

15. The computing device of claim 14, further comprising circuitry configured to, in response to the determination that the instruction does not request to load data from the memory of the computing device and based output of the thread scheduler, arbitrate execution on the processor pipeline among the plurality of threads on a coarse-grained basis.

16. The computing device of claim 10, wherein:
the set of execution units is configured to execute, after the requested data is loaded into the physical register space, one or more instructions from the particular thread; and
the register allocation manager further comprises circuitry configured to:
receive, from the particular thread, a deallocation command associated with the loaded data; and
deallocate the one or more physical register addresses for the thread.

17. The computing device of claim 16, wherein a thread scheduler arbitrates access to the processor pipeline among the plurality of threads on a coarse-grained basis while the one or more instructions from the particular thread are executing until (1) the deallocation command is received or (2) the one or more instructions comprise a load request.

18. The computing device of claim 16, wherein the deallocation command comprises a particular value of a deallocation bit in one of the one or more instructions.

19. The computing device of claim 18, wherein a number of deallocation bits in each of the one or more instructions is equal to a number of operands in each of the respective one or more instructions.

20. The computing device of claim 16, wherein the deallocation command comprises a deallocation instruction.
